(19) United States
(12) Patent Application Publication
(10) Pub. No.: US 2005/0269735 A1
(43) Pub. Date: Dec. 8, 2005

(54) Polymeric fibre extrusion

(76) Inventors: Aldo Benetti, Germiston (ZA); Johan Fourie, Pretoria (ZA); Ivor Mzwandile Zwane, Sasolburg (ZA)

Correspondence Address: C James Bushman;Browning Bushman, Suite 1800, 5718 Westheimer, Houston, TX, 77057-5771, US

(21) Appl. No.: 10/521,831

(22) PCT Filed: Jul. 28, 2003
(86) PCT No.: PCT/IB03/02986

§ 371 Date: Jun. 27, 2005

(30) Foreign Application Priority Data
Jul. 26, 2002 (ZA) 20025993
Nov. 13, 2002 (ZA) 20029237

(51) Int. Cl. B29C 47/00; C10L 1/16

(52) U.S. Cl. 264/176.1; 264/211; 585/10

(57) ABSTRACT

The method of extruding a polymer comprising adding a linear low molecular weight polymer to a polymer to be processed to form a mixture and extruding the mixture so formed.

### BACKGROUND OF THE INVENTION

THIS invention relates to polymeric fibre extrusion.

Synthetic filaments and fibres are usually produced via an extrusion process whereby the polymer (e.g., polypropylene, polyethylene, polyester, nylon, etc.) is melted and forced through fine holes known as spinnerets. The fibres are then stretched or drawn until the required weight (or denier) is achieved.

The drawing process involves a continuous stretching of the solid polymer fibre of filament at a temperature slightly below its melt temperature and is used to align long polymer molecules in the fibre- or filament drawing direction which gives the fibre- or filament its strength. The degree of stretching (described by the draw ratio) determines the fibre strength (tenacity) and ultimate elongation properties. The production of fine fibres or filaments requires a polymer which:
(i) has a low enough viscosity in the melt that it can be extruded through the fine spinnerets at a sufficiently high rate without the onset of draw resonance or melt fracture; and,
(ii) has a high enough molecular weight that the mechanical strength of the fibres or filaments is sufficient to prevent breakages during drawing. Furthermore, the properties of the fibre or filament need to meet the requirements of the final application.

Unfortunately the polymer requirements for good processability do not result in good final properties, and vice versa. Processing of low molecular weight polymers results in weak fibres or filaments at best, but low molecular weight are usually not processable at commercially important extrusion outputs due to filament breakages and often result in die build-up and dripping. While better property fibres and filaments are produced using higher molecular weight polymers, this comes at a cost during processing when high torques are required to extrude the more viscous melt. This may be overcome somewhat by processing at higher temperatures; however these result in thermal degradation of both the polymer (which leads to decreased mechanical properties) and additives or adjuvant substances such as pigments mixed with the polymer. The use of high torques leads to high power consumption of the extruder, which also contributes to the cost of fibre or filament production.

### SUMMARY OF THE INVENTION

According to the invention there is provided a method of extruding a polymer, typically a method for producing polymeric filaments and fibres from a polymer, the method including the steps of:
1. adding a linear low-molecular weight polymer to the polymer to be processed prior to extrusion; and
2. extruding the mixture so formed.

The linear low-molecular weight polymer typically has a chain length of C₃₀ to C₁₀₀₀, preferably C₈₀ to C₁₂₀.

The low-molecular weight polymer is a wax, preferably a wax produced by the Fischer-Tropsch process.

In the Fischer-Tropsch process, synthesis gas (carbon monoxide and hydrogen) is reacted over an iron, cobalt, nickel or ruthenium containing catalyst to produce a mixture of hydrocarbons ranging from methane to waxes and smaller amounts of oxygenates.

In a low temperature Fischer-Tropsch reaction, the reaction takes place in a slurry bed reactor or fixed bed reactor, preferably a slurry bed reactor, at a temperature in the range of 160° C.-280° C., preferably 210° C.-260° C., and a pressure in the range of 18-50 bar, preferably between 20-30 bar, in the presence of a catalyst. The catalyst may include iron, cobalt, nickel or ruthenium. However, a cobalt-based catalyst is preferred for the low temperature reaction. Usually, the cobalt catalyst is supported on an alumina support.

Preferably, the wax of the invention has an initial boiling point of at least 300° C. at 101.3 kPa.

From 0.5% to 25% w/w preferably from 1% to 4% w/w linear low-molecular weight polymer may be added to the polymer to be processed.

The linear low-molecular weight polymer may be melt blended or simply mixed with the polymer to be processed prior to the extrusion step.

The invention also relates to an extruded polymeric product containing from 0.5% to 25% w/w preferably from 1% to 4% w/w linear low-molecular weight polymer having a chain length from C₃₀ to C₁₀₀₀, typically from C₈₀ to C₁₂₀.

### DESCRIPTION OF EMBODIMENTS

This invention relates to an improved method for the production of polymeric fibres or filaments in an extrusion process. Typical polymers that may be processed are polypropylene (homopolymer and copolymer), polyethylene (low density, linear low density and high density) as well as blends thereof. According to the invention, a linear low-molecular weight polymer is added to the polymer being processed prior to the extrusion process.

Typical low-molecular weight polymers include linear polymethylene with very little branching (preferably <5 CH₃/1000C). Chain lengths of C₃₀ to C₁₀₀₀ are suitable although chain lengths of C₈₀ to C₁₂₀ are preferred. Particularly suitable linear low-molecular weight polymers are waxes which are produced in the Fischer-Tropsch process. A suitable wax has an initial boiling point of at least 300° C. at 101.3 kPa such as the wax Enhance™ which is a proprietary wax of the Applicant.

The amount of low-molecular weight polymer which is added to the polymer to be processed depends on the solubility of the low-molecular weight polymer in the polymer to be processed. Usually the low molecular weight polymer will be added in the amount of between 0.5% to 25% w/w, preferably 1% to 4% w/w.

In one embodiment, a method according to the invention is carried out by mixing a polymer to be processed with a linear low-molecular weight polymer as described above. The mixture is then fed to an extruder which is operated at temperatures of between 110° C.-300° C., depending on the polymer run, typically 110° C.-200° C. for LDPE and LLDPE, 130° C.-220° C. for HDPE and 170° C.-280° C. for PP. The actual temperature profile used as well as the melt temperature of the polymer depends on the linear density of the filament, fibre or tape being produced, the processing equipment and the converter preferences. The melted polymer is extruded either as a sheet or as tapes or as monofilaments into either a chilled airbox or chilled water bath (water temperature typically 5° C.-30° C.) or onto a chilled roller. The extruded filament, fibre or tape is then heated through an annealing oven or over a hot-plate or on heated godets, the temperature of which depends on the polymer run, as well as the line speed, but is typically set about 80° C.-100° C. (LDPE and LLDPE), 100° C.-130° C. (HDPE) and 110° C.-150° C. (PP). Draw ratios between 1:2 and 1:12 may be used, although typical ratios of between 1:4 and 1:8 provide the best balance of properties (tenacity and elongation).

The presence of the low molecular weight polymer in the polymer to be processed acts as a viscosity modifier during processing. The use of this viscosity modifier results in the following:
(i) lower torques than otherwise required to extrude a polymer with the same molecular weight and molecular weight distribution characteristics at the same melt temperature. The polymer therefore experiences less shear during processing and is less degraded resulting in stronger fibres and filaments with a superior balance of properties;
(ii) lower extruder torque is reflected as lower electrical power requirements. This may be enjoyed as a cost saving or, in the case where the extruder is running at capacity the use of the invention allows for increased outputs becoming possible by using the additional power available from the easier processing to increase the screw speed;
(iii) the easier processability of polymer with the same molecular weight also means the polymer can be processed at a lower temperature without higher motor torques being necessary. Lower temperatures result in less thermal degradation and are required when temperature sensitive pigments are used; and reduce the levels of smoking or fuming of volatile products or degradation by-products;
(iv) lower processing temperatures also result in a reduced fibre- or filament-cooling requirement. The rapid cooling (quenching) of the molten fibres extruded from the spinnarets is an important control parameter in the production of fibres and filaments, poor or slow cooling results in a more crystalline fibre or filament which cannot easily be drawn without breaking;
(v) the reduction of melt viscosity when using the invention described also mean that a higher molecular weight polymer can be processed without higher demands on the extruder motor than when running a lower molecular weight polymer without the addition of the described invention;
(vi) although there are a number of variables which effect fibre- or filament strength, as a general rule-of-thumb tenacity and elongation are inversely proportional to one another at draw ratios of commercial interest. Obtaining a high tenacity at low draw ratios will result in tapes with good ultimate-elongation properties. The addition of the described invention acts as a solid-state viscosity modifier at the temperatures used for drawing. This results in easier drawing and higher tenacities are attained while simultaneously allowing higher ultimate-elongation properties to be achieved;
(vii) the ability to produce high tenacity fibres- or filaments at lower draw ratios benefits converters with equipment limited in the draw ratios possible. It also allows for power savings during drawing;
(viii) the addition of the described invention running the same draw ratio will result in higher ultimate-elongation fibres or filaments being produced than using the same base polymer under the same process conditions without the addition of the invention up to the point where the fibre or filament is overdrawn; and
(ix) the addition of the described invention also allows converters to run heavier (higher denier) fibres and filaments at outputs not readily achievable without the addition of the invention.

Set out below are non-limiting examples of the invention and comparative examples:

### EXAMPLE 1

### Increased Output Using Less Extruder Amps

Standard temperature profile 205° C./215° C./225° C. (barrel) 235° C. (adaptor & melt pump) 240 (die); waterbath quench ca. 30° C., godets at 12 m/min, 78 m/min and 75 m/min; draw oven 158° C., annealing oven 130° C.

a) Comparative PP (random copolymer): 17 rpm produces 240 den/26 Tex monofilament—extruder draws 23 A

b) PP (random copolymer)+2% Enhance™ Wax: 19 rpm produces 280 den/30 Tex monofilament (16% heavier filament)—extruder draws 19A (8% less amps)

### EXAMPLE 2

### Lower Process Temperature can be Run Without Additional Power Requirements

a) Comparative PP (random copolymer): Temperature profile: 205° C./215° C./225° C. (barrel) 235° C. (adaptor & melt pump) 240° C./240° C.(die); other conditions as above

17 rpm produces 240 den/26 Tex monofilament—extruder draws 23 A

b) PP (random copolymer)+2% Enhance™ Wax: Temperature profile: 190° C./196° C./201° C. (barrel) 207° C. (adaptor & melt pump) 215° C./215° C. (die); other conditions as above

14 rpm produces 236 den/25 Tex monofilament (similar weight filament)

extruder draws 19A (8% less amps)

### EXAMPLE 3

### Lower Extruder Amps when Using Wax-1

Standard temperature profile 200° C./215° C./220° C./220° C./220° C./220° C./215° C.

a) PP (homopolymer MFI 2 g/10 min.): output 140 kg/hr, 100 rpm-70 A

b) PP (homopolymer MFI 2 g/10 min+1% Enhance™ Wax): output 140 kg/hr, 100 rpm-60 A

c) PP (homopolymer MFI 2 g/10 min+2% Enhance™ Wax): output 140 kg/hr, 100 rpm-59A

### EXAMPLE 4

### Lower Extruder Amps when Using Wax-2

Standard temperature profile 200° C./215° C./220° C./220° C./220° C./220° C./215° C.

a) Comparative PP (homopolymer MFI 3.5 g/10 min): output 140 kg/hr, 100 rpm-60 A

b) PP (homopolymer MFI 3.5 g/10 min+1% Enhance™ Wax): output 140 kg/hr, 100 rpm-55 A

c) PP (homopolymer MFI 3.5 g/10 min+2% Enhance™ Wax): output 140 kg/hr, 100 rpm-53 A

### EXAMPLE 5

### Lower MFI Polymer can be Processed at Comparable Extruder Amp Requirements when Waxes are Used

Standard temperature profile 200° C./215° C./220° C./220° C./220° C./220° C./215° C.

a) Comparative PP (homopolymer MFI 3.5 g/10 min): output 140 kg/hr, 100 rpm-60 A

b) PP (homopolymer MFI 2 g/10 min+1% Enhance™ Wax): output 140 kg/hr, 100 rpm-60 A

c) PP (homopolymer MFI 2 g/10 min+2% Enhance™ Wax): output 140 kg/hr, 100 rpm-59 A

1. A method of extruding a polymer comprising:
1. adding a linear low-molecular weight polymer to the polymer to be processed to form a mixture; and
2. extruding the mixture so formed.

2. A method according to claim 1, wherein the method is for producing polymeric filaments and fibres from the polymer.

3. A method according to claim 1, wherein the linear low-molecular weight polymer has a chain length of C₃₀ to C₁₀₀₀.

4. A method according to claim 3, wherein linear low-molecular weight polymer typically has a chain length of C₈₀ to C₁₂₀.

5. A method according to claim 3, wherein the linear low-molecular weight polymer is a wax.

6. A method according to claim 5, wherein the wax produced by the Fischer-Tropsch process.

7. A method according to claim 6, wherein the wax has an initial boiling point of at least 300° C. at 101.3 kPa.

8. A method according to claim 1, wherein from 0.5% to 25% w/w linear low-molecular weight polymer is added to the polymer to be processed.

9. A method according to claim 8, wherein from 1% to 4% w/w linear low-molecular weight polymer is added to the polymer to be processed.

10. A method according to claim 1, wherein the linear low-molecular weight polymer is melt blended or simply mixed with the polymer to be processed prior to the extrusion step.

11. An extruded polymeric product containing from 0.5% to 25% w/w linear low-molecular weight polymer having a chain length from C₃₀ to C₁₀₀₀.

12. A product according to claim 11, wherein the linear low-molecular weight polymer has a chain length of C₈₀ to C₁₂₀.

13. A product according to claim 11 which is a polymeric filament or fibre.

14. A product according to claim 11, wherein the linear low-molecular weight polymer is a wax.

15. A product according to claim 14, wherein the wax is produced by the Fischer-Tropsch process.

16. A product according to claim 15, wherein the wax has an initial boiling point of at least 300° C. at 101.3 kPa.

17. A product according to claim 11, wherein the linear low-molecular weight polymer comprises 1% to 4% w/w of the product.
